(19) United States
(12) Patent Application Publication
(10) Pub. No.: US 2008/0133368 A1
(43) Pub. Date: Jun. 5, 2008

(54) Entertainment, business transaction, information, telecommunications package

(76) Inventors: Margaret M. Spolar, Montrose, PA (US); Eddie Carr, Las Vegas, NV (US)

Correspondence Address: Mark Levy;HINMAN, HOWARD & KATTELL, LLP, 80 Exchange Street, P.O. Box 5250, BINGHAMTON, NY, 13901, US

(21) Appl. No.: 11/985,393

(22) Filed: Nov. 15, 2007

Related U.S. Application Data
(60) Provisional application No. 60/872,860, filed on Dec. 5, 2006.

(51) Int. Cl. G06Q 30/00; G06Q 90/00

(52) U.S. Cl. 705/14

(57) ABSTRACT

A method for acquiring and distributing entertainment content and telecommunications time in a single package. Entertainment content is first acquired by purchase, license or assignment. Telecommunications time is also acquired by means of an appropriate agreement with a provider of telecommunications services. Both the acquired entertainment content and the acquired telecommunications time are packaged on a medium, which is then sold as a single unit. A contest may be conducted for a customer based on information residing on the medium. The medium may be a CD, a DVD, a phone card, a debit card, a credit card, an Internet file, etc. The medium may include a serial number.

### RELATED APPLICATIONS

This application is a Continuation-in-Part of Provisional U.S. Patent Application Ser. No. 60/872,860, filed Dec. 5, 2006 and claims priority thereto in accordance with 35 U.S.C. §1.78.

### FIELD OF THE INVENTION

The invention pertains to a method and apparatus for distributing entertainment content, business information, telecommunications and monetary funds and, more particularly, to a method of combining at least two of entertainment, business information, telecommunications and monetary funds in a single package, providing benefits to the consumer.

### BACKGROUND OF THE INVENTION

Communications and entertainment are used every day. In fact, a high percentage of the fee for music or movies, for example, to a consumer is for the purchase of a DVD or CD. Whether they are used to hold music, movies, games, data or computer software, CDs and DVDs have become a standard medium for distributing large quantities of information in a reliable package, easy and cheap to produce.

A CD may be used for storing data or downloads from the Internet. There cannot be extended gaps due to bumps in the data track. Data are encoded using EFM (eight-fourteen modulation). 8-bit bytes are converted to 14-bit bytes. It is guaranteed by EFM that some of those bits will be 1s. Because a laser reader moves between songs, data must be encoded into the music to indicate the location thereof on the disc. The problem is solved by using what is known as subcode data. This subcode data can encode the absolute and relative position of the laser in the track, and can also encode such things as songs. Because the laser may misread a bump, error-correcting codes are provided to handle errors. Extra data bits are added that allow the drive to detect errors and correct them.

Digital recording converts an analog wave to a stream of numbers and records the numbers instead of the wave. The conversion is performed by an analog-to-digital (A/D) converter. To play back the music, the stream of numbers is converted back to an analog wave by a digital-to-analog (D/A) converter. The analog wave is amplified and fed to the speakers to produce the sound. The sampling rate is 44,100 samples per second and the number of gradations is 65,536.

The track pitch of a DVD is smaller, and the minimum pit length for a single-layer DVD is smaller than for a CD. Thus, there is room for about 4.5 times as many pits on a DVD as on a CD. To increase the capacity of a DVD even more, a DVD can have up to four layers, two on each side. The laser that reads the disc can actually focus on the second layer through the first layer.

Telephone companies are responsible for the telephone lines that carry calls. Resellers buy telephone minutes from carriers. Issuers set the card rates and provide toll-free customer service and access numbers. Distributors sell the cards to retailers. Retailers sell the cards to consumers, although it is important to remember that a store may not have control over the quality of the card or the service it provides. Telecommunication devices including cell phones, satellite radio or voice over IP, connects each user to one another.

A prepaid phone card is a card purchased to make long distance phone calls. The phone card can be used anywhere and, because it is paid in advance, there is no bill. Prepaid phone cards are popular among travelers, students, and people who frequently call overseas.

Pay as you go cards work much the same way. Most every phone card uses a personal identification number (PIN). A third party such as InComm has a direct connection with companies such as ATT, Sprint and/or Verizon and it becomes the inter media for programming cards. Phone cards are activated through the carrier (ATT, etc.) which has a database of PIN numbers, assigned to the third party and kept in a central terminal. The carrier links the PIN database number to the third party, which then links the number to a certain company. The manufacturer also receives the PIN and places it on the card (via printing, bar coding, magnetic encoding, etc.) during manufacturing. The PIN is not active until its sale by a retailer.

The PIN may activate through a mag strip, a bar code, etc., depending on which system and/or database terminal has been set up by the retail store to read the PIN. When the user purchases the phone card at the register, the data is sent through the system in place with that retailer. The information is then sent to the carrier's central terminal to inform the carrier of the sale. The carrier can then activate the PIN number and send a data wave to the partner. Customers who purchase either Fastcard or Fastpin can use a toll-free number to activate their account. Finally, the PIN number may be activated automatically prior to sale to the customer.

A liaison such as InComm Interactive Voice Response (IVR) system gives customers easy-to-follow prompts to enter the PIN and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

Prepaid mobile phone cards are used with phones that a customer buys prior to purchasing minutes as needed. Prepaid cell phone cards allow the customer to pay for only the minutes needed. With prepaid mobile phone cards, the air-time from the recharge card is added just once, whereas the whole balance of the recharge card is added to the phone. All calls are made without a dialing PIN.

Funds deposited into the user's account expire after six months. If additional funds are placed into the account before the current account balance expires, the existing balance is carried over to the new expiration date. For all incoming service, the length of the call is measured during the time that the user is connected to the system, which is approximately from the time the user presses ‘Send’ or another key to answer a call, until approximately the time the user presses ‘End,’ or another key to terminate the call.

A credit card is a thin plastic card, usually 3⅛ inches by 2⅛ inches in size, which contains identification information such as a signature or picture, and authorizes the person named on it to charge purchases or services to his account, charges for which he is billed periodically. Under the plan, the bank credits the account of the merchant as sales slips are received and assembles charges to be billed to the cardholder at the end of the billing period. The cardholder, in turn, pays the bank either the entire balance or in monthly installments with interest.

Credit card numbers are in sets. The first set stands for system numbers, the second set for bank numbers, the third set account numbers and the fourth set stands for check diget.

A credit card has a magnetic strip on the back and a place for the user's signature. A credit card typically uses only tracks one and two. Track three is a read/write track, which includes an encrypted PIN, country code, currency units and amount authorized, but its usage is not standardized among banks.

The information on track one appears in one of two formats: A, which is reserved for proprietary use of the card issuer, and B, which includes the following:
Start sentinel—one character
Format code=“B”—one character (alpha only)
Primary account number—up to 19 characters
Separator—one character
Country code—three characters
Name—two to 26 characters
Expiration date or separator—four characters or one character
Discretionary data—enough characters to fill out maximum record length (79 characters total)
End sentinel—one character
Longitudinal redundancy check (LRC)—one character in the form of computed check character.

The format for track two, developed by the banking industry, is as follows:
Start sentinel—one character
Primary account number—up to 19 characters
Separator—one character
Country code—three characters
Expiration date or separator—four characters or one character
Discretionary data—enough characters to fill out maximum record length (40 characters total)
LRC—one character

There are three basic methods for determining whether a user's credit card will pay for what he or she is charging:

Merchants with few transactions each month perform voice authentication using a touch-tone phone.

Electronic data capture (EDC) magstripe-card swipe terminals are becoming more common, requesting the user to swipe his or her own card at the checkout.

For virtual terminals on the Internet, after the user or the cashier swipes a credit card through a reader, the EDC software at the point-of-sale (POS) terminal dials a stored telephone number (using a modem) to call an acquirer. An acquirer is an organization that collects credit-authentication requests from merchants and provides the merchants with a payment guarantee.

A “Smart” credit card has a microprocessor built into the card itself. The user must corroborate his identity to the card each time a transaction is made, in much the same way that a PIN is used with an ATM. The card and the card reader execute a sequence of encrypted sign/countersign-like exchanges to verify that each is dealing with a legitimate counterpart. Once this has been established, the transaction itself is carried out in encrypted form to prevent anyone, including the cardholder or the merchant whose card reader is involved, from “eavesdropping” on the exchange and later impersonating either party to defraud the system.

This elaborate protocol is invisible to the user, except for the necessity of entering a PIN to begin the transaction.

A debit card looks much like a credit card. Instead of accessing a credit line, however, a debit card accesses a checking or savings account. The result is that, instead of incurring a debt and reducing the amount of available credit, a debit card is used to spend money the user already has. As cash is withdrawn from ATMs or purchases are made, the funds are debited (deducted) from the bank account.

When the user makes purchases from a merchant, he or she may use the card exactly like a credit card is used: sign for the purchases or use a PIN to process the charge. When using a PIN, the funds are deducted from the user's account immediately or within the same day. When signing for purchases like a credit card, it may take one to three days for the deduction to be made from the bank account.

With the FastPin system, the customer receives a printed receipt containing a PIN and instructions on how to use the product rather than a printed and/or embossed plastic card. With FastPin, the user can use the existing credit card terminal or POS system to generate the printed receipt. This activation method allows for unlimited just-in-time inventory and immediate activation.

The Fastcard system runs on the industry's credit card network, so the customer can use existing POS terminals, which provide instant validation of product redemption and authorize a customer return at the point of sale, which instantly issues credit for returns.

### SUMMARY OF THE INVENTION

In accordance with the present invention, there is provided a method for acquiring and distributing entertainment content and telecommunications time in a single package. Entertainment content is first acquired by purchase, license or assignment. Telecommunications time is also acquired by means of an appropriate agreement with a provider of telephone services. Both the acquired entertainment content and the acquired telecommunication time are packaged on a medium which is then sold as a single package. A contest may be conducted for the user based on information residing on the medium. The medium may be a CD, a DVD, a phone card, an iphone card, an iTunes card, an eMusic card, a debit card, a credit card, an Internet file, etc. The medium may include a serial number or PIN.

### BRIEF DESCRIPTION OF THE DRAWINGS

A complete understanding of the present invention may be obtained by reference to the accompanying drawings, when considered in conjunction with the subsequent detailed description, in which:

FIG. 1a is a schematic view of a package in accordance with the invention, showing a telecommunication medium and an entertainment medium;

FIG. 1b is a schematic view of the reverse side of the package shown in FIG. 1a;

FIG. 2 is a flow chart of user operations in utilizing a telecommunications media (e.g., a telephone card);

FIG. 3 is a flow chart of manufacturer/distribution operations in acquiring and distributing entertainment content and telecommunications time; and

FIG. 4 is a flow chart depicting user operations in participating in a contest relating to the inventive package.

### DETAILED DESCRIPTION OF THE PREFERRED EMBODIMENT

The invention is a method of providing and distributing telecommunications media such as phone cards with entertainment media such as CDs/DVDs in a single package. Entertainment content is first acquired by purchase, license or assignment. Telecommunications time is also acquired by means of an appropriate agreement with a provider of telephone services. Both the acquired entertainment content and the acquired telecommunication time are packaged on a medium, which is then sold or rented as a single package.

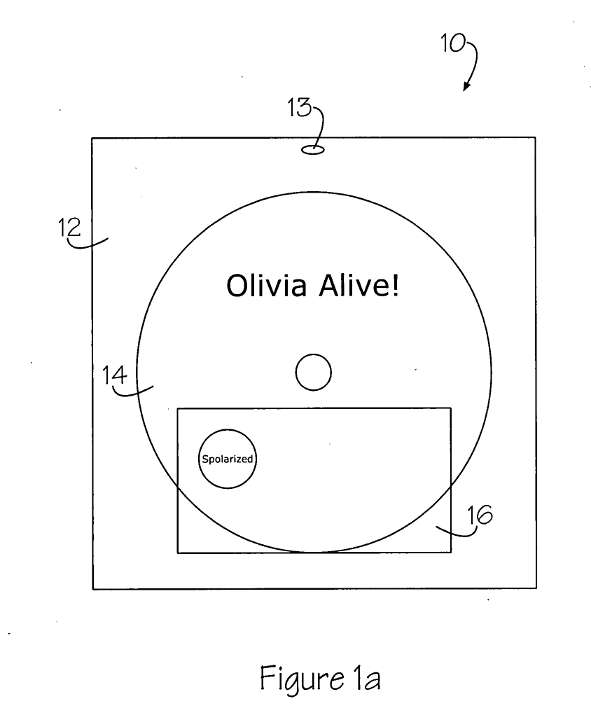

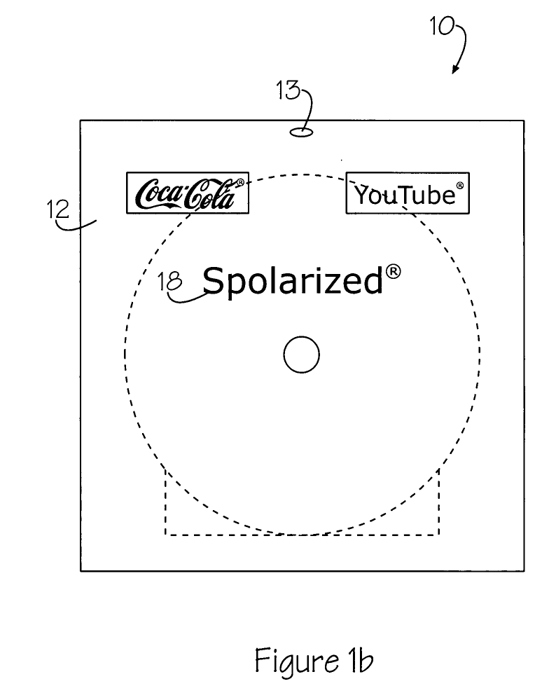

Referring now to FIGS. 1a and 1b, there is shown generally at reference number 10, a combination package or collection. A cardboard, laminated cardboard or plastic substrate 12 has an aperture 13 for hanging on a store display rack, not shown. Substrate 12 may be any suitable material for carrying out its function. Written material, such as the advertisement for a Spolarized® product, for example shown as reference number 18, can be printed on either or both front and rear sides of substrate 12. The written material may be used for advertising products of other manufacturers or vendors.

Entertainment media in the form of a CD, mini-CD or DVD 14 is attached and carried by the substrate 12. CDs and DVDs can be produced in any of a number of formats such as rewritable CD-R, DVD+R, high density, etc. It should be understood that other forms of the entertainment media such as, but not limited to entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include but are not limited to digital files residing on electronic devices such as memory sticks, non-volatile memory cards, MP3 players, optical storage disks, multimedia cards, SanDisk, Apple ipods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, Walkman, MP3 FM tuner, iMove Boom Box, iPod Nano, ipod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iphone, Bluetooth, camera phones, Motorola RAZR, NeXus satellite radio, MP3/DVD/CD/WMA receiver ipod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, You Tube, Kiosk, music downloads, movie downloads, parents cards, points cards, electronic video cards, Free Leader, GPhone, mobile caller, itune7, PDA's, Trac-Fone, WIFI, Blue Ray, mobile web and email, SanDisk Sansa, CB radio, walkie-talkie, digital cable, HBO Cinamax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash and non-cash rewards, points cards, satellite radio digital music, Internet-based applications, including Flicker Photos, iphone, T-Mobile, STI mobile, Net10, Edge and WIFI laptop PC cards (T-Mobile), Smartphones, Express cards, T-Mobile to Go, Text messaging, Java Games, WAV/AAC/AACT music players, walkman, PC card, USB modem, video share calling, micro SD, mini SD, Media players, MMS, QuickShare, messaging packing MSN, YAHOO, AOL, ICQ, AIM, Billboards, multimedia messaging, data download speed burst, upload burst, 2way SMA, dual band, Quad-Band (GPRS/EDGE) worldwide communication, instant messenger, Edge technology high speed data, Yahoo Messenger, and the like.

The separate distribution of each product typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo WII, Xbox, Play Station 2, Play Station 3, PSP, and the like have been sold separately.

A registration serial number, not shown, is embedded in the entertainment media 14 and optionally printed on substrate 12 and/or on a label therefore, Advertising can also be printed on media labels. The serial number is discussed in greater detail below. Moreover, printed material, such as advertising 18 (FIG. 1b) can be printed on entertainment media 14. Such printed material 18 can likewise be disposed on the face and/or obverse of entertainment media 14. Moreover, advertising in the form of sound and/or images can be embedded before, during or after the content stored on the entertainment media 14, itself, for play or display to the user.

Telecommunication media in the form of a plastic or other suitable physical card 16 is attached and carried by the substrate 12. It should be understood that other telecommunications media can be provided, as desired, without departing from the scope of the invention. In the preferred embodiment, plastic card 16 has a magnetic strip, not shown, attached to one surface thereof. The strip includes digital information representative of the number of telephone calling minutes purchased. In applying the magnetic strip, a suitable machine prints the card 16. The card 16 then is fed to a different machine that glues the strip not shown or a static bar to the card 16. The card 16 is then sent to a different machine that codes the bar. The magnetic strip is a thin layer of magnetizable material that is placed on conventional or rechargeable (PINGO®) phone cards, iphone cards, land line telephone cards, smart cards with embedded IC chip(s), credit cards, targeted credit cards (gas cards, store cards, student cards, parent cards, teen credit cards, etc.) bank ATM cards, debit cards, no-fee cards, gift cards, international phone cards, prepaid phone cards, pay as you go cards, money cards, travel cards, monetary fund cards, club cards, dinner cards, mobile phone memory cards, mobile prepaid plan cards, Internet service cards, and laptop cards, mobile phone cards, cellular phones, T-mobile, Virgin Mobile, Slice, Bluetooth, Zune to Zune, iFlops, camera phones, Motorola RAZR, NeXus satellite radio, iPhone, MP3/DVD/CD/WMA receiver ipod and XM-ready, Ticketmaster, band credits cards, debit cards, ATM cards, Internet service, membership cards, rewards cards, promotional cards, celebrity cards, ring tones, photo cards, merchandise cards, iTune cards, eMusic cards, entertainment cards, cards, music download, free loader, parents load, electronic video games, Kiosks cards, mobile tracker, cash and non-cash cards, walkie talkie, Mobile TV, WIFI, Trac-Fone, ring tones, GPhone, cardless calling cards, Internet-based applications, QAV/AAC/AACT music player, and wireless gift cards.

The strip is a plastic material with magnetizable powder mixed in with it. The strip can be magnetized by exposing it to a strong magnetic field. Bits of the composition can be magnetized in different directions by a device that generates a strong magnetic field over a short distance. The strip can have many North and South poles on it. The numbers and locations of the poles are used to encode information.

The strip is read with a similar (or even the same) device that wrote it. The process also works in reverse. By moving the strip back and forth over a read head, voltages are induced in coils that can be amplified and recorded electronically, so that information can be sent to a computer. The PIN may activate through a mag strip, a bar code, etc., depending on which system and/or database terminal has been set up by the retail store to read PIN numbers. When the user purchases a phone card 16 at a register, the data are sent through the system that is in place with that retailer. The information is then sent to the carrier's central terminal to inform the carrier that the sale took place. The carrier then activates the PIN and sends a data wave to the partner.

As aforementioned, printed material such as advertising can be printed on either or both sides of substrate 12 on entertainment media 14, as well as on calling card/credit card, debit card, gift card, etc. 16.

Certain applications blur the distinction between entertainment and telecommunications, such as Blackberry service, WiFi, Yahoo, satellite radio (Sirius), San Disk memory cards, subscription services, broadband Internet service DMX digital music, iphone, and Sansa Connect music players.

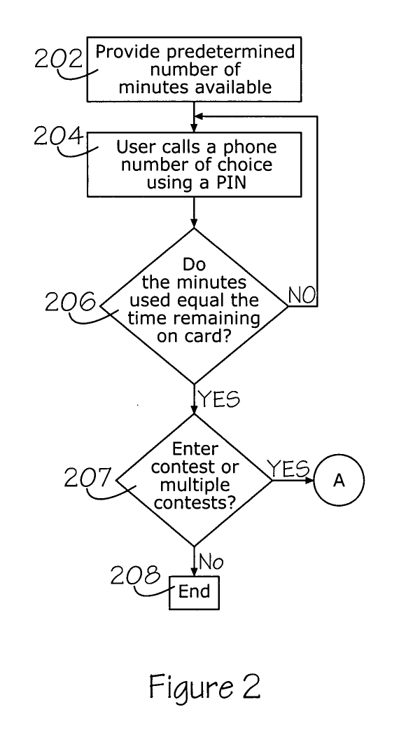

Referring now to FIG. 2, there is shown a flow chart of phone card operations. The card is provided with a predetermined number of minutes available, step 202.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, T-mobile, Virgin Mobile, Slice, Bluetooth, Zune to Zune, iphone, iFlops, camera phones, Motorola RAZR, NeXus satellite radio, MP3/DVD/CD/WMA receiver ipod and XM-ready, TracFone wireless, Chocolate, INpulse, Firefly, Ticketmaster, U3 Data Traveler, Walkman, ZenV, Impulse, Sirus Cable, Cable Service, Instant messaging, Internet Service and Communication, Television Communication, Radio Communication, Satellite Communication, Email, etc.

The user calls a phone number using a PIN, step 204. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 204 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

The number of minutes remaining on the card equals the original number of minutes paid for, less time used with the card, rounded up, step 206. Rounding is the billing increment unit. One Minute Rounding means that the billing increment is 1 minute. A call for 50 seconds, for example, is billed as 1 minute. Three Minute Rounding means that the billing increment unit is 3 minutes. A call for 7 minutes and 50 seconds is billed as 9 minutes. One plus three Minute Rounding means that for calls less than 1 minute, the user is charged for 1 minute. For calls more than 1 minute, the first minute is charged 1 minute and the following minutes are charged at 3 minute increments. A call for 2 minutes and 50 seconds is billed as 4 minutes.

The user decides whether to enter a TEC contest, step 207. For purposes of this disclosure, a “contest” is intended to include, but not be limited to, a prize, a sweepstake, a chance and consideration for the acquisition thereof. The user can decide to enter the contest by following the directions on the package 10 (FIG. 1a). There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like.

It should be understood that land line service can be purchased, and used in connection with the present invention, in which case a discount is available to encourage a user to maintain and retain his land line service. Minutes or cash payable to a user's bill can be claimed by a user who avails himself of the inventive product and services.

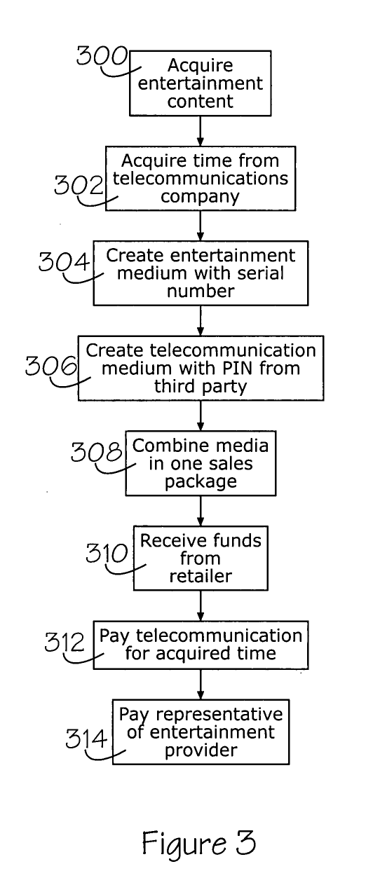

Referring now to FIG. 3, there is shown a flow chart of operations for acquiring and distributing entertainment content and telecommunications options. Entertainment content is acquired, step 300. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, Nintendo WII, Play Station 2 and 3, PSP, entertainment cards that offer services, or gift cards for the purchase of certain entertainment products, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, PSP, and the like. The content is in the form of a CD/DVD, but is not limited thereto. For example, other forms of expression (e.g., written material) are contemplated herein.

Time is acquired from one or more telecommunications companies, step 302. The purchased time is encoded on a magnetic strip across the phone card 16 (FIG. 1a). The time can be activated when sold, although certain phone cards are prepaid.

An entertainment medium is created with a serial number, step 304, the serial number being placed on the entertainment medium itself.

A telecommunications medium is created with a PIN number, step 306. The PIN is placed on the telecommunications card and/or bank credit card, debt card, ATM card, iTune, eMusic card, Internet service medium, gift card, membership card, rewards card, entertainment card, Ticketmaster, promotional card, celebrity card, and the like, which may or may not match other serial numbers within the package.

A liaison such as InComm Interactive Voice Response (IVR) system can give customers easy-to-follow prompts to enter the pin and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

The telecommunications and entertainment media are combined in one package, step 308. Accordingly, the telecommunication and entertainment package now contains a phone card, a DVD or CD with entertainment programming, and a rewards contest.

Funds are received from one or more retailers, step 310. The retailer reports the sale or rental of the telecommunications and entertainment package on a monthly basis, preferably, but other periodic or non-periodic time frames can be negotiated. The retailer forwards the money from the sale or rental of the telecommunication and entertainment package on a monthly or quarterly basis, but shorter or longer payment periods can be negotiated. For purposes of this disclosure, the words “sale”, “sell” and “selling” are intended to include the concepts of renting and rented.

Telecommunications companies are paid for the acquired time, step 312, by the TEC. Minutes are paid as they are used or may be paid all at once for the telecommunications and entertainment package when purchased.

A representative of the entertainment provider is paid, step 314. The provider of the entertainment receives funds after the telecommunications and entertainment package has been purchased and the money has been received from the sale.

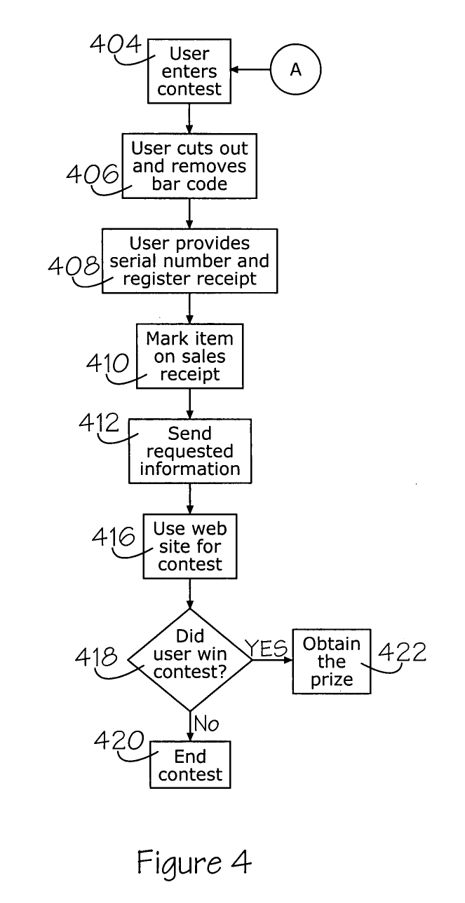

Referring now to FIG. 4, the user can enter a contest, step 404. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 406, and mails it with the required information.

The rules of the contest(s) require certain information and the serial number, or multiple serial numbers that pertain to the package, along with a register receipt, step 408. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 410. The user circles the register receipt and mails or emails the bar code and the register receipt to the address on the telecommunications and entertainment package, step 412.

The web site is used to enter the contest or contests, step 416. The user can email certain information through the web site following the same process described hereinabove. If the user wins the contest, step 418, he can claim his prize, step 422.

The telecommunications and entertainment package holds a contest periodically to award a winner. The winner receives a prize selected by the telecommunications and entertainment company. The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 420, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of package 10. The advertisement may also be included on the calling cards and/or the actual CD/DVDs themselves, or within the entertainment media so as to be displayed, performed or heard while listening to the CD/DVD or seen on a user's video display monitor.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. A method for acquiring and distributing entertainment content and information representative of monetary funds in a single package, the steps comprising:
a) acquiring entertainment content;
b) acquiring information representative of monetary funds; and
c) selling said entertainment content and said information representative of monetary funds as a single package.

2. The method for acquiring and distributing entertainment content and information representative of monetary funds in a single package in accordance with claim 1, the steps further comprising:
d) conducting at least one contest for a customer based on information residing on said medium.

3. The method for acquiring and distributing entertainment content and information representative of monetary funds in a single package in accordance with claim 1, wherein said entertainment content and said information representative of monetary funds are embodied in a medium chosen from the group: CD, mini-CD, DVD, phone card, iphone card, iTune card, eMusic card, debit card, credit card, Internet file, digital file residing on electronic devices, memory sticks, non-volatile memory cards, MP3 players, optical storage disks, multimedia cards, SanDisk, Apple ipods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Play Station 2 and 3, TracFone, Chocolate, INpulse, Firefly, U3 Data Traveler, Digital MP3 WMA, ZenV, Walkman, MP3 FM tuner, iMove Boom Box, ipod Nano, ipod Talking Shoe, Audovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, Bluetooth, camera phones, iphone, Motorola RAZR, NeXus satellite radio, MP3/DVD/CD/WMA receiver ipod and XM-ready, Ticketmaster, band credit card, ATM card, Internet service, gift card, membership card, rewards card, promotional card, celebrity card, ring tones, photo card, merchandise cards, entertainment card, music download, free loader, parents load, electronic video games, you tube, kiosks cards, mobile tracker, Amp'd card, promotional card, music downloads, movie downloads, electronic video games, You Tube, kiosks cards, cash and non-cash cards, points cards, satellite radio, GPhone, wireless gift cards, mobile caller, camera phone, itune7, PDA's, Trac-Fone, WIFI, Blue Ray, mobile web and email, SanDisk, CB radio, walkie-talkie, digital cable, HBO Cinamax, DVR service, boost mobile, Xing tone software, Broadband cards, digital music, Micro Max, Photo MP3, Coral Snapfire, Napster, Mobile TV, Travel and Entertainment cards (T&E), Pennytalk, air travel, Sunnysoft calling cards, no-fee cards, cardsless cards, T-Mobile, my Faves, cellular video, STI mobile, Smartphones, Net10, Edge and WIFI laptop PC card (T-Mobile), Go Phones, Express card, USB modem, PC card, walkman, Text messaging, Java games, T-Mobile to Go, video share calling, micro SD, Video streaming, media players, MMS, QuickShare, mini SD, Edge technology high speed data, messaging packing MSN/YAHOO/AOL/AIM/ICQ, Billboards, multimedia messaging, data download speed burst, upload burst, 2way SMS, dual band, Quad-band (GPRS/EDGE) worldwide communication, stereo wireless, GPS enabled, WAC/AAC/AACT music player, and wireless gift card.

4. The method for acquiring and distributing entertainment content and information representative of monetary funds in a single package in accordance with claim 2, wherein said contest is conducted by using the Internet.

5. The method for acquiring and distributing entertainment content and information representative of monetary funds in a single package in accordance with claim 3, wherein said medium comprises at least one serial number.

6. A single package for providing entertainment content and information representative of monetary funds comprising:
a) a first medium for holding entertainment content; and
b) a second medium for holding information representative of monetary funds.

7. The single package for providing entertainment content and information representative of monetary funds in accordance with claim 6, wherein said first medium comprises at least one from the group: CD, mini-CD, DVD, phone card, iphone card, iTune card, eMusic card, debit card, credit card, Internet file, digital file residing on electronic devices, memory sticks, non-volatile memory cards, MP3 players, optical storage disks, multimedia cards, SanDisk, Apple ipods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Slice, Play Station, TracFone, Chocolate, INpulse, Firefly, U3 Data Traveler, Digital MP3 WMA, ZenV, Walkman, MP3 FM tuner, iMove Boom Box, ipod Nano, ipod Talking Shoe, Audovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, iPhone, Bluetooth, camera phones, Motorola RAZR, NeXus satellite radio, MP3/DVD/CD/WMA receiver ipod and XM-ready, Ticketmaster, band credit card, ATM card, Internet service, gift card, membership card, rewards card, promotional card, celebrity card, ring tones, photo card, merchandise cards, entertainment card, Amp'd card, promotional card, walkie-talkie, digital cable, mobile web and email, SanDisk, CB radio, Gphone, mobile caller, movie downloads, music downloads, Photo cards, travel and entertainment cards, You Tube, Kiosk cards, parents cards, points cards, electronic video cards, Free Leader, Itune7, PDA's, Trac-Fone, WIFI, Blue Ray, SanDisk Sansa, HBO Cinamax, DVR service, boost mobile, Xing tone software, Broadband cards, Napster, Travel and Entertainment card (T&E), Pennytalk software calling cards, air travel, house cards, Mobile TV, Microsoft Max, Photo MP3, Corel Snapfire, no-fee cards, cardless calling cards, mobile tracker, cash and non-cash cards, T-Mobile, Dash phone, my Faves, cellular video, STI mobile, Smartphones, Net10, Go Phones, Express cards, Edge and WIFI laptop PC card (T-Mobile), USB modem, PC card, walkman, text messaging, Java games, video share calling, video streaming, media players, MMS, microSD, miniSD, Edge technology high-speed data, Quick Share, messaging packing AIM/MSN/YAHOO/AOL/ICQ, Billboards, multimedia massaging, data download speed burst, upload burst, 2way SMS, dual band, Quad-Band (GPRS/EDGE) worldwide communication, stereo wireless, GPS enabled, WAV/AAC/AACT music player, and wireless gift card.

8. The single package for providing entertainment content and information representative of monetary funds in accordance with claim 7, wherein said second medium comprises at least one from the group: CD, mini-CD, DVD, phone card, iphone card, iTune card, eMusic card, debit card, credit card, Internet file, digital files residing on electronic devices, memory sticks, non-volatile memory cards, MP3 players, optical storage disks, multimedia cards, SanDisk, Apple ipods, solid state devices (ROMs), iphone, Bluetooth handsets, Blackberry devices, HP iPAQ, Palm, Zune to Zune, iFlops, MP3, MP3 pillows, Virgin Mobile, Slice, Zen Micro Photo MP3, T-Mobile, cellular telephones, Xbox, Nintendo WII, Nintendo DS, Nintendo. GameCube, Gameboy, computer games, PSP, Play Station, TracFone, Chocolate, INpulse, Firefly, U3 Data Traveler, Digital MP3WMA, ZenV, Walkman, MP3 FM tuner, Move Boom Box, ipod Nano, ipod Talking Shoe, Audovox Xpress, Micro SD, XM card, satellite radio digital music, Internet-based application, including Flicker Photos, NeXus satellite radio, MP3/DVD/CD/WMA receive ipod and XM-ready, Ticketmaster, band cards, band credit cards, Internet service, gift cards, laptop cards, pay-as-you-go-cards, Gphone, MP3/DVD/CD/WMA receiver ipod and XM-ready, Internet service, gift cards, rewards cards, promotional cards, membership cards, celebrity cards, entertainment cards, ring tones, photo card, merchandise card, AMP'd card, pay-as-you-go-wireless, wireless gift card, You Tube, Kiosk, music downloads, movie downloads, parents card, points card, electronic video cards, Free Loader, landline telephone, mobile caller, itune7, PDA's, Trac-Fone, WIFI, Blue Ray, mobile web and email, SanDisk Sana, CB radio, walkie-talkie, digital cable, HBO Cinamax, DVR service, boost mobile, Xing tone software, Broadband cards, cash and non-cash cards, satellite radio digital music, Napster, Microsoft Max, Photo MP3, Corel Snapfire, Mobile TV, house cards, travel and entertainment cards (T&E), Pennytalk, Sunny software calling cards, no-fee cards, cardless cards, T-Mobile, my Faves, cellular video, STI mobile, Smartphones, Net10, Edge and WIFI laptop PC card (T-Mobile), T-mobile to Go, Go Phone, Express card, USB modem, PC card, walkman, text messaging, Java games, video share calling, micro SD, video streaming, mini SD, edge technology high speed data, MMS, media players, QuickShare, messaging packing AIM/MSN/YAHOO/AOL/ICA, Billboards, multimedia messaging, data download speed burst, upload burst, 2way SMS, dual band, Quad-Band (GPRS/EDGE) worldwide communication, stereo wireless, GPS enabled, WAV/AAC/AACT music player, and Yahoo Messenger.

9. The single package for providing entertainment content and information representative of monetary funds in accordance with claim 6, said single package further comprising:
c) at least one serial number.

10. The single package for providing entertainment content and information representative of monetary funds in accordance with claim 6, further comprising:
c) means for qualifying to participate in a contest.

11. The single package for providing entertainment content and information representative of monetary funds in accordance with claim 9, wherein a prize for winning said contest is chosen from the group: car, recreational vehicle, case, stock, product, meal, recording deal, travel, jewelry, hotel reservation, special event, movie deal, and any other item or deal.

12. The single package for providing entertainment content and information representative of monetary funds in accordance with claim 6, further comprising:
c) at least one advertising message.

13. The single package for providing entertainment content and information representative of monetary funds in accordance with claim 12, wherein said at least one advertising message is disposed on or in one of the group: the label of said first medium, the label of said second medium, embedded in said first medium, embedded in said second medium, and on said single package.

14. A single package for providing entertainment content and second entertainment content comprising:
a) a first medium for holding first entertainment content; and
b) a second medium for holding second entertainment content.

15. The single package for providing entertainment content and second entertainment content in accordance with claim 14, wherein said first medium comprises at least one from the group: CD, mini-CD, DVD, phone card, iphone card, iTune card, eMusic card, debit card, credit card, Internet file, digital file residing on electronic devices, memory sticks, non-volatile memory cards, MP3 players, optical storage disks, multimedia cards, SanDisk, Apple ipods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, Walkman, MP3 FM tuner, iMove Boom Box, ipod Nano, ipod Talking Shoe, Audovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, Bluetooth, camera phones, iphone, Motorola RAZR, NeXus satellite radio, MP3/DVD/CD/WMA receiver ipod and XM-ready, Ticketmaster, band credit card, ATM card, Internet service, gift card, membership card, travel cards, rewards card, promotional card, celebrity card, ring tones, photo card, merchandise cards, entertainment cards, Amp'd card, Internet service cards, laptop cards, mobile phone cards, landline telephone, satellite radio, MP3/DVD/CD/WMA receiver ipod and XM-ready, Ticketmaster, band credit cards, wireless gift cards, You Tube, Kiosk, music downloads, movie downloads, parents cards, points cards, electronic video cards, Free Loader, GPhone, mobile caller, itunes7, PDA's, Trac-Fone, WIFI, Blue Ray, mobile web and email, SanDisk Sansa, CB radio, walkie-talkie, digital cable, HBO Cinamax, DVR service, boost mobile, Xing tone software, Broadband cards, cash and non-cash cards, Internet-based applications, Photo MP3, Microsoft Max, Napster, Corel Snapfire, Mobile TV, house cards, Travel and Entertainment cards (T&E), Pennytalk, Sunnysoft calling cards, no-fee cards, cardless calling cards, and T-Mobile, callular video, STI mobile, my Faves, Smartphones, Net10, Edge and WIFI laptop PC card (T-Mobile), Expree card, USB modem, T-Mobile to Go, PC card, walkman, text messaging, Java games, video share calling, micro SD, video streaming, mini SD, Edge technology high speed data, media players, MMS, QuickShare, messaging packing AIM/MSN/YAHOO/AOL/ICQ, Billboards, mulitmedia messaging, data download speed burst, upload burst, 2way SMS, dual band, Quad-Band (QPRS/EDGE) worldwide communication, stereo wireless, GPS enabled, WAV/AAC/AACT music player, and wireless gift card.

16. The single package for providing entertainment content and second entertainment content in accordance with claim 14, said single package further comprising:
c) at least one serial number.

17. The single package for providing entertainment content and second entertainment content in accordance with claim 14, further comprising:
c) means for qualifying to participate in a contest.

18. The single package for providing entertainment content and second entertainment content in accordance with claim 14, wherein said contest is conducted by using the Internet.

19. The single package for providing entertainment content and second entertainment content in accordance with claim 17, wherein a prize for winning said contest is chosen from the group: car, recreational vehicle, case, stock, product, meal, recording deal, travel, jewelry, hotel reservation, special event, movie deal, and any other item or deal.

20. The single package for providing entertainment content and second entertainment content in accordance with claim 14, further comprising:
c) at least one advertising message disposed on or in one of the group: the label of said first medium, the label of said second medium, embedded in said first medium, embedded in said second medium, and on said single package.
